(19) United States
(12) Patent Application Publication
(10) Pub. No.: US 2015/0124016 A1
(43) Pub. Date: May 7, 2015

(54) WEB STEERING FRAMES THAT INCLUDE AN INDEPENDENTLY ADJUSTABLE ROLLER

(71) Applicants: Carl Bildstein, Lafayette, CO (US); Stuart Boland, Denver, CO (US); Scott Johnson, Erie, CO (US); Casey Walker, Boulder, CO (US)

(72) Inventors: Carl Bildstein, Lafayette, CO (US); Stuart Boland, Denver, CO (US); Scott Johnson, Erie, CO (US); Casey Walker, Boulder, CO (US)

(73) Assignee: RICOH COMPANY LTD, Tokyo (JP)

(21) Appl. No.: 14/070,111

(22) Filed: Nov. 1, 2013

(51) Int. Cl. B41J 15/04

(52) U.S. Cl. CPC B41J 15/046
USPC 347/16; 347/104

(57) ABSTRACT

Systems and methods are provided for controlling webs of print media. One embodiment is an apparatus that includes a steering frame for a continuous-forms printing system. The steering frame includes a first roller oriented to tension a web of continuous-forms print media as the web proceeds through the steering frame, and a second roller oriented to tension the web as the web proceeds through the steering frame. The steering frame also includes a first actuator configured to adjust a lateral position of the web by pivoting the first and second roller about a first axis, and a second actuator configured to adjust a direction of the web in-plane with a surface of the web by pivoting the second roller about a second axis that is coplanar with the first axis.

### FIELD OF THE INVENTION

The invention relates to the field of continuous-forms printing systems, and in particular, to steering frames for webs of continuous-forms printing systems.

### BACKGROUND

Entities with substantial printing demands typically use a production printer. A production printer is a high-speed printer used for volume printing (e.g., one hundred pages per minute or more). Production printers include continuous-forms printers that print on a web of print media stored on a large roll.

While a continuous-forms printer operates, the web is quickly passed underneath the nozzles of printheads of the printer, which discharge ink onto the web at intervals to form pixels. In order to ensure that the web is consistently positioned as it moves downstream from one printhead to another, steering systems may align the web laterally with respect to its direction of travel.

Steering systems may be calibrated when the printer is first installed. However, even when the web is initially aligned properly, fluctuations in the physical properties of the web (e.g., variations along the edge of the web, changes in lateral tension along the web, orientation of the fibers in the web, etc.) may cause the web to lose its alignment during printing. This in turn causes the printheads to discharge ink onto the wrong pixel locations within the web. Thus, even small individual shifts can substantially reduce print quality.

For example, consider a continuous-forms printing system having multiple printheads that each discharge a different color of ink (e.g., Cyan, Magenta, Yellow, and Key black) onto the web. When the printheads are used by the printer to form a mixed color pixel, a small fluctuation in web position can cause an upstream printhead to mark the correct physical location, while a downstream printhead marks the wrong physical location. This distorts the final color of the pixel in the printed job, which is undesirable.

### SUMMARY

Embodiments described herein utilize a steering frame that is capable of correcting the alignment of a web of print media. The steering frame includes two rollers that can be pivoted about an axis (e.g., to shift the position of a web entering the steering frame). Furthermore, one of the rollers can be independently pivoted about another axis (e.g., to adjust an angle of direction of the web). This allows a wide variety of adjustments to be performed upon the web as it travels through the steering frame.

One embodiment is an apparatus that includes a steering frame for a continuous-forms printing system. The steering frame includes a first roller oriented to tension a web of continuous-forms print media as the web proceeds through the steering frame, and a second roller oriented to tension the web as the web proceeds through the steering frame. The steering frame also includes a first actuator configured to adjust a lateral position of the web by pivoting the first and second roller about a first axis, and a second actuator configured to adjust a direction of the web in-plane with a surface of the web by pivoting the second roller about a second axis that is coplanar with the first axis.

Another embodiment is a method for operating a steering frame that includes multiple rollers in order to adjust a web of print media. The method includes identifying a positional offset of a web of print media proceeding through a steering frame of a printing system, identifying a skew of the web in-plane with a surface of the web, pivoting multiple rollers of the steering frame about a first axis based on the positional offset, and pivoting one of the multiple rollers about a second axis that is coplanar with the first axis based on the skew.

Another embodiment is an apparatus that includes a frame, a first roller that is rotatably attached to the frame and oriented to support a web of continuous-forms print media that travels through the apparatus, and a second roller that is rotatably attached to the frame and oriented to support the web. The apparatus also includes a first actuator configured to pivot the frame about a first axis, and a second actuator configured to pivot the second roller about a second axis that is coplanar with the first axis.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a diagram of a printing system in an exemplary embodiment.

FIG. 2 is a diagram of a web of print media traveling through a printing system in an exemplary embodiment.

FIG. 3 is a diagram of web of print media having a positional offset in an exemplary embodiment.

FIG. 4 is a diagram of web of print media having an angular deviation in an exemplary embodiment.

FIG. 5 is a side view of a printing system in an exemplary embodiment.

FIG. 6 is a top view of the printing system of FIG. 5 in an exemplary embodiment.

FIG. 7 is a diagram of two rollers of a steering frame being pivoted about one axis in order to account for a positional offset of a web of print media in an exemplary embodiment.

FIG. 8 is a diagram of a single roller of a steering frame being pivoted about an axis in order to account for an angular deviation of a web of print media in an exemplary embodiment.

FIG. 9 is a flowchart illustrating a method for operating a steering frame in an exemplary embodiment.

FIG. 10 is a side view of an additional printing system in an exemplary embodiment.

FIG. 11 is a top view of the printing system of FIG. 10 in an exemplary embodiment.

FIG. 12 is a side view of an additional printing system in an exemplary embodiment.

FIG. 13 is a top view of the printing system of FIG. 12 in an exemplary embodiment.

FIG. 14 is a diagram illustrating a drive system configured to adjust the position of a roller in an exemplary embodiment.

FIG. 15 is a diagram illustrating an additional drive system configured to adjust the position of a roller in an exemplary embodiment.

FIG. 16 illustrates a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

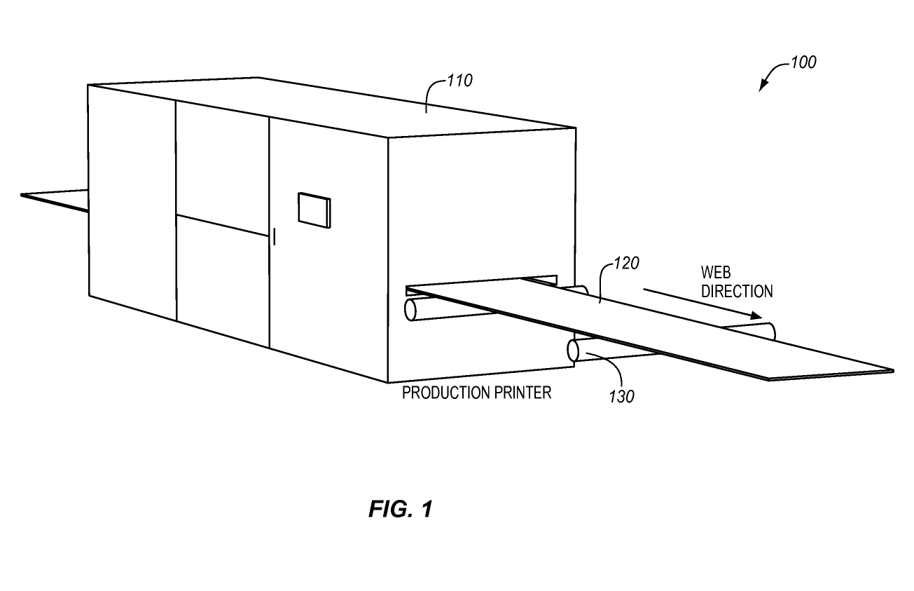

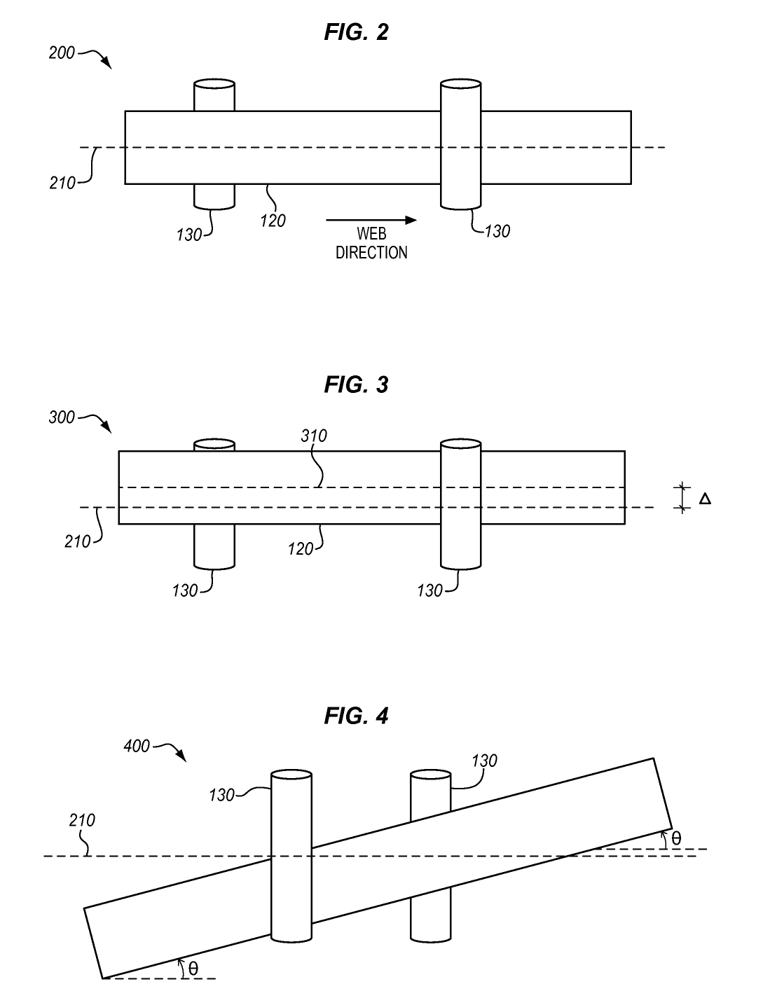

FIG. 1 is a diagram of a continuous-forms printing system 100 in an exemplary embodiment. Printing system 100 includes production printer 110, which is operable to mark web 120 of continuous-forms print media (e.g., a web of paper). As used herein, the act of marking refers to any suitable technique of visually altering web 120. For example, the act of marking can comprise applying a marking fluid (e.g., aqueous inks, oil-based paints, etc.) or toner. The act of marking may even comprise stamping, cutting, or scorching web 120 for the purpose of generating visible marks. In FIG. 1, printer 110 comprises an inkjet printer that applies colored inks, such as Cyan (C), Magenta (M), Yellow (Y), and Key (K) black inks. One or more rollers 130 position web 120 as it travels through printing system 100. FIGS. 2-4 further discuss positioning and alignment of a web for a continuous-forms printing system.

FIG. 2 is a diagram 200 of a web of print media 120 traveling through a printing system in an exemplary embodiment. As shown in FIG. 2, web 120 is centered with respect to rollers 130 as it travels over rollers 130. In particular, the lateral center of web 120 is aligned with center line 210, which bisects rollers 130. For the purposes of this discussion, a shift of web 120 away from center line 210 is considered a positional offset of web 120. However, in an operating printing system, the default alignment of web 120 need not be centered with respect to rollers 130. For example, web 120 may be aligned based on the position of one or more of its edges with respect to printer 110.

FIG. 3 is a diagram 300 of a misaligned web of print media 120 traveling over rollers 130 in an exemplary embodiment. In FIG. 3, the lateral center of web 120 (indicated as element 310) is offset from center line 210 by an amount A. This positional offset impacts print quality, and is therefore undesirable. As used herein, a positional offset/lateral offset is a change in position or tension that is within the plane of the web and orthogonal to the direction of travel of the web (i.e., orthogonal to the length of the web, and parallel to the width of the web).

FIG. 4 is a diagram of web 120 having an angular deviation in an exemplary embodiment. In FIG. 4, web 120 deviates by an angle θ from its intended direction of travel. Values of θ may vary, for example, between about zero degrees and about fifteen degrees in either direction. Angular deviations (also known as “skew”) can be particularly problematic because they cause the positional offset of web 120 to change over time as web 120 travels through the printing system.

While FIGS. 3-4 illustrate specific offsets and deviations in a web of print media 120, any positional and/or angular shift of a web from its expected orientation in a printing system can be considered a misalignment.

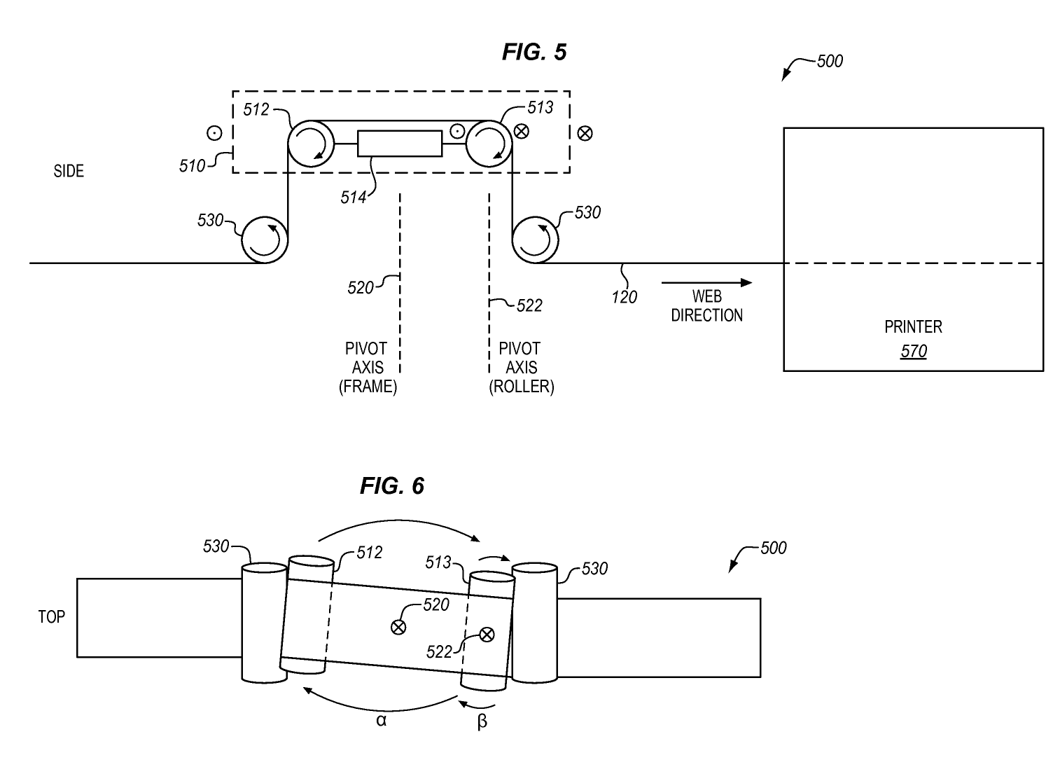

FIG. 5 is a side view of a printing system 500 in an exemplary embodiment (a top view of printing system 500 is shown in FIG. 6). Printing system 500 includes steering frame 510, which has been enhanced to account for both positional and angular shifts in a web of print media 120, thereby correcting for the alignment issues discussed with regard to FIGS. 3-4.

As used herein, a “steering frame” comprises a connected arrangement of mechanical components (i.e., mechanically coupled regardless of whether a web is loaded into the frame) that can be used to orient a web of continuous-forms print media. For example, the components of a steering frame may be integrated together via a frame (or other support structure) and enclosed by a housing. A steering frame may further include electrical components for directing the operations of the various mechanical components.

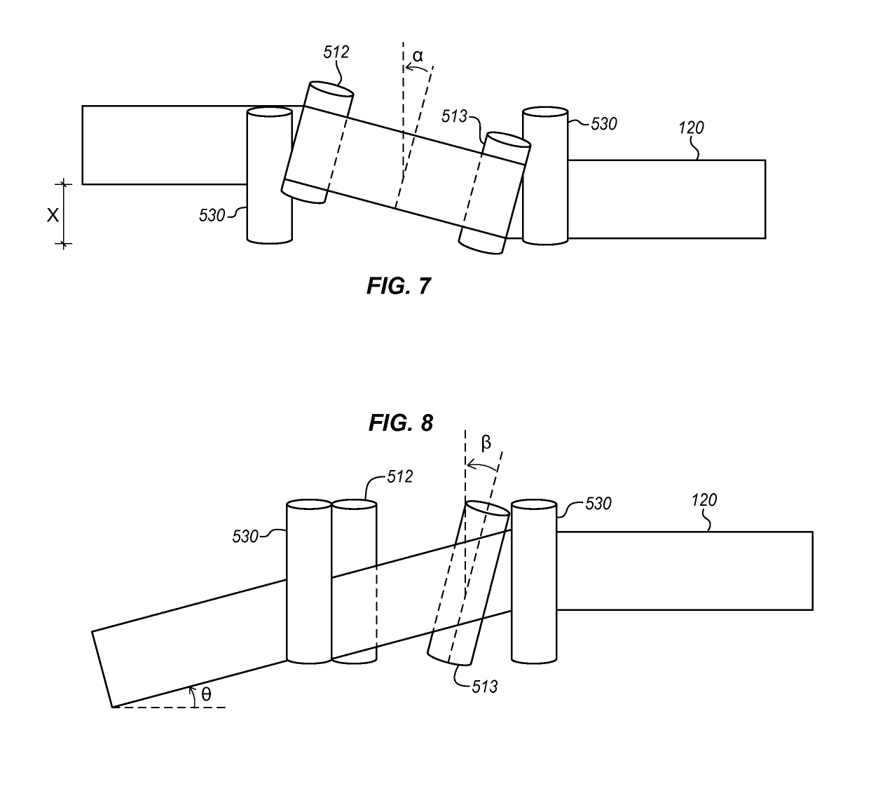

Steering frame 510 is able to pivot rollers 512-513 (and/or the entirety of steering frame 510) about axis 520. The pivoting of both rollers about axis 520 is indicated in FIG. 5 by the vectors into and out of the page that are proximate to steering frame 510. As used herein, a vector into the page is represented by a circle with an “X” inside of it, while a vector out of the page is represented by a circle with a dot inside of it. This pivoting of the rollers about axis 520 is also indicated in FIG. 6 by the long arrows. By pivoting both rollers at once about axis 520 by an amount α, steering frame 510 can correct for a positional offset “X” that has been detected at web 120 (as shown in FIG. 7).

Steering frame 510 is also able to pivot roller 513 about axis 522, which is coplanar with axis 520. Another way to describe axis 522 is that axis 522 is substantially perpendicular to the axis of rotation of roller 513. The pivoting of roller 513 is indicated in FIG. 5 by the vectors into and out of the page that are located proximate to roller 513. This pivoting is also indicated in FIG. 6 by the short arrows. By pivoting roller 513 about axis 522 by an amount β, steering frame 510 can account for detected angular deviations of web 120 in-plane with the surface of web 120 (as shown in FIG. 8). In this embodiment, axis 520 is parallel with axis 522. Since axis 522 is positioned relative to roller 513, axis 522 may translate (i.e., move) when steering frame 510 pivots about axis 520. Additionally, while an “output” roller 513 is shown as being independently pivoted about axis 522, in further embodiments it may be the “input” roller (e.g., roller 512) that is independently pivoted about an axis.

Steering frame 510 utilizes drive system 514 to pivot the rollers about axes 520 and 522. Drive system 514 comprises any suitable arrangement of components and devices operable to pivot both of rollers 512 and 513 (and/or the entirety of steering frame 510) about axis 520, and further operable to pivot roller 513 about axis 522, which in this embodiment travels through the center of roller 513. Drive system 514 may comprise internal and/or external actuators, such as linear drives or rotational drives, and these drives may push/rotate one or more shafts connected with the rollers in order to properly orient the rollers.

Printing system 500 further includes printer 570 and rollers 530. Printer 570 marks web 120, and rollers 530 weave web 120 through printing system 500.

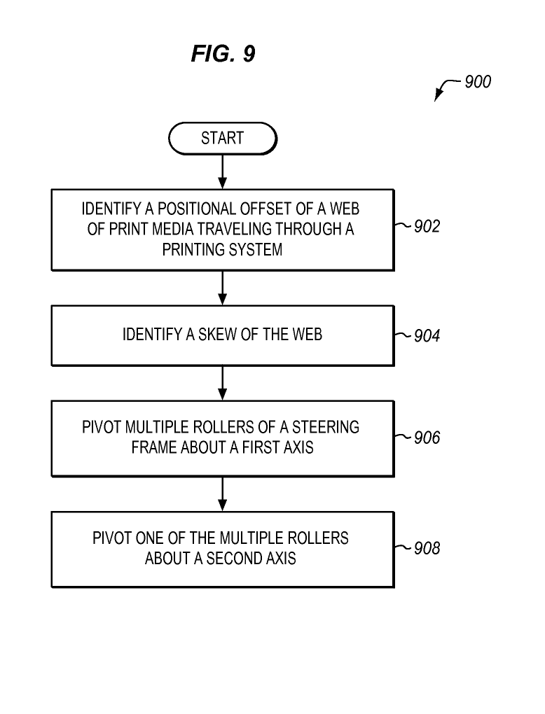

The particular arrangement, number, and configuration of components described herein is exemplary and non-limiting. Illustrative details of the operation of printing system 500 will be discussed with regard to FIG. 9. Assume, for this embodiment, that printing system 500 is currently in the process of marking web 120 to generate physical output for a print job. Further, assume that web 120 is traveling through steering frame 510. As web 120 travels through steering frame 510, natural variations in web 120 cause its lateral position and angle to shift back and forth.

FIG. 9 is a flowchart illustrating a method 900 for operating a steering frame in an exemplary embodiment. The steps of method 900 are described with reference to printing system 500 of FIGS. 5-6, but those skilled in the art will appreciate that method 900 may be performed in other systems. The steps of the flowcharts described herein are not all inclusive and may include other steps not shown. The steps described herein may also be performed in an alternative order.

In step 902, a controller of steering frame 510 (e.g., a processor or circuit) identifies a positional offset of web 120 as it travels through printing system 500. In one embodiment, the positional offset is determined based on positional input from one or more feed forward and/or feedback sensors. In step 904, a controller of steering frame 510 identifies an in-plane angular deviation of the direction of web 120 (i.e., a skew of the web). In one embodiment, the angular deviation is determined based on the received positional input. For example, the angular deviation may be determined by calculating an angle based on two positional offsets provided by sensors at different web locations, and also based on a known distance between those sensors.

In step 906, the controller compensates for the positional offset by directing drive system 514 to pivot rollers 512 and 513 about axis 520 (as shown in FIG. 7). For example, pivoting the rollers may comprise operating a rotational actuator to pivot the entirety of steering frame 510 about axis 520. In a further embodiment, the pivoting occurs at a rate of about ten hertz in response to detected positional shifts in web 120.

In step 908, the controller compensates for the skew by directing drive system 514 to pivot roller 513 about axis 522 (as shown in FIG. 8). For example, the controller may instruct a linear actuator to reposition roller 513 by pivoting roller 513 about axis 522. In a further embodiment, the pivoting occurs at a rate of about half of a hertz in response to small detected angular deviations in web 120. Adjusting the angle of web 120 at a slower rate than the position of web 120 may keep web 120 from shearing, ripping, or tearing.

Using method 900, a steering frame can be used to automatically compensate for detected shifts in both the angle and position of a web of print media, even during printing in response to changing input from one or more sensors.

In a further embodiment, adjusting the orientation of roller 513 to compensate for an angle of deviation may also “walk” web 120, causing it to shift position. To address this issue, the controller may cause further pivots about axis 520 in order to account for the positional shift imparted by the adjustments made by roller 513.

Printing System with Alternate Pivot Axes

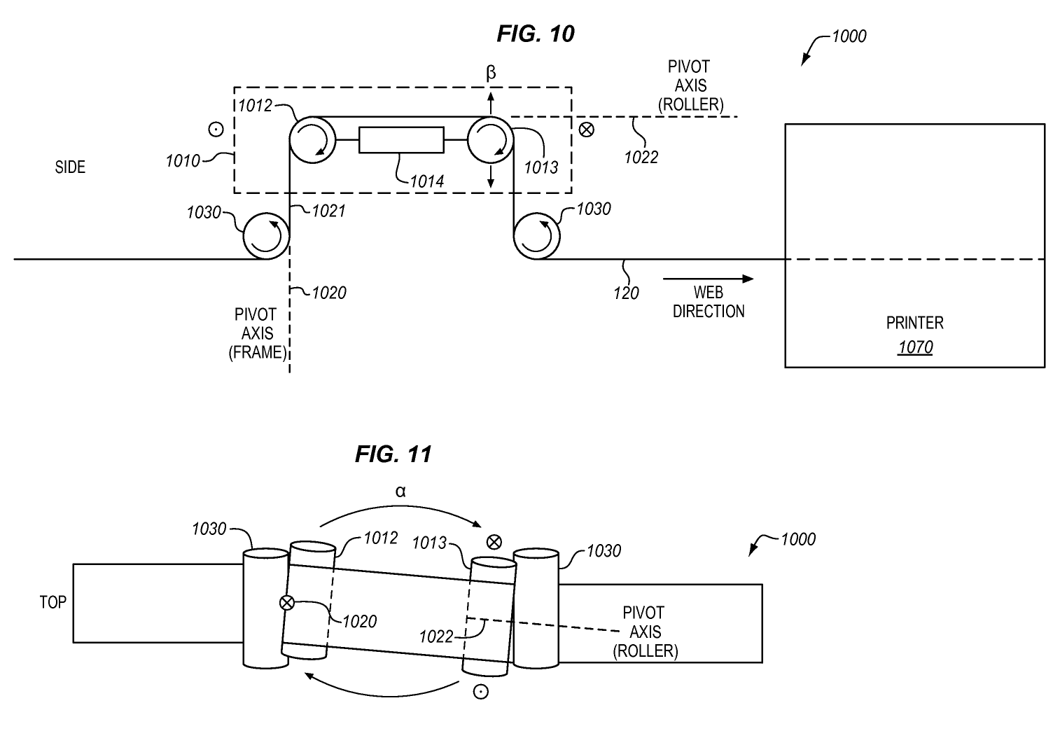

FIG. 10 is a side view of an additional printing system 1000 in an exemplary embodiment (a top view of printing system 1000 is shown in FIG. 11). In FIG. 10, the pivot axes of the printing system are placed and/or oriented differently than in FIG. 5.

For example, the pivot axis for rollers 1012 and 1013 (and/or the entirety of steering frame 1010) in printing system 1000 is located substantially within the plane defined by the face of web 120 before web 120 enters steering frame 1010 (i.e., axis 1020 is located substantially within the face indicated by element 1021). Axis 1020 is also substantially parallel with the direction of travel of web 120 before web 120 enters steering frame 1010. Offsetting the pivot axis for both rollers (and/or steering frame 1010) to this location can help to reduce the stresses applied to web 120 as it travels through steering frame 1010. Furthermore, axis 1020 can even be offset to the point where it is entirely external to steering frame 1010 (i.e., axis 1020 can be moved to a location where it becomes a virtual pivot that does not intersect steering frame 1010).

The pivoting of both rollers about axis 1020 is indicated in FIG. 10 by the vectors into and out of the page that are proximate to steering frame 1010. This pivoting is also indicated in FIG. 11 by the long arrows. By pivoting both rollers at once about axis 1020 by an amount α, steering frame 1010 can correct for positional offsets that have been detected at web 120.

Steering frame 1010 is also able to pivot roller 1013 about axis 1022, which is coplanar with axis 1020, yet also oriented differently than axis 522 of FIG. 5. Specifically, in this embodiment axis 1020 is perpendicular to axis 1022. The pivoting of roller 1013 is indicated in FIG. 10 by the small arrows that are located proximate to roller 1013. This pivoting is also indicated in FIG. 11 by the unnumbered vectors into and out of the page. By pivoting roller 1013 about axis 1022 by an amount β, steering frame 1010 can account for detected angular deviations of web 120.

Drive system 1014 operates to pivot rollers 1012 and 1013 as desired. Printing system 1000 also includes printer 1070 for marking onto web 120, as well as rollers 1030 for weaving web 120 towards printer 1070.

Printing System with Control Sensors

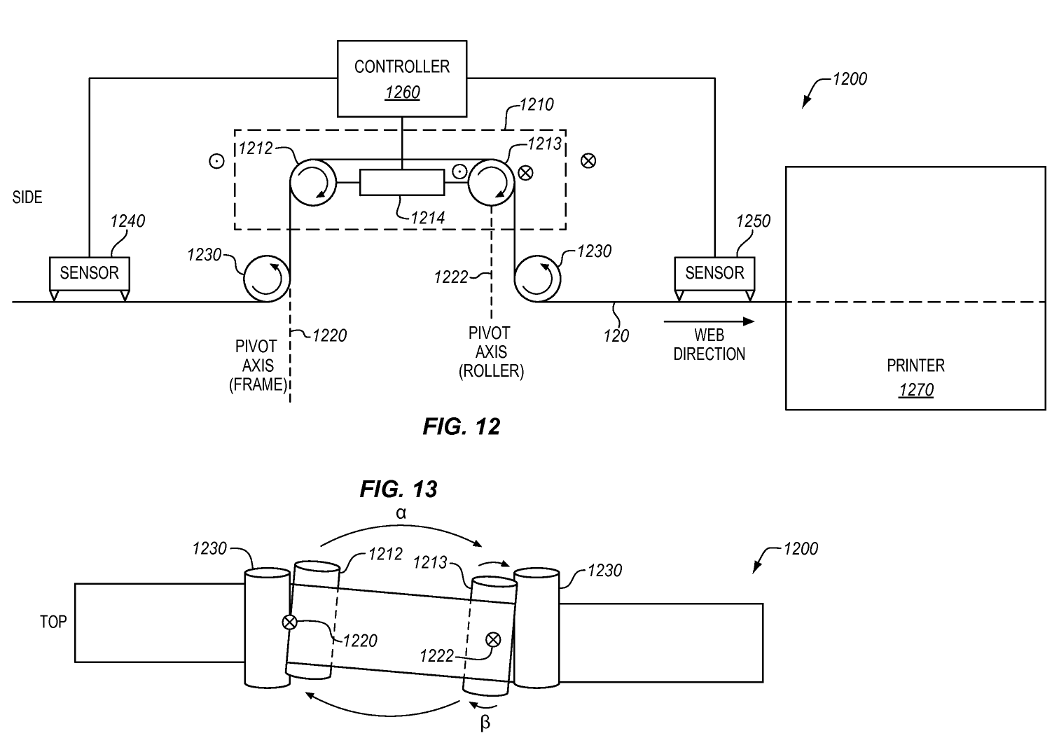

FIG. 12 is a side view of an additional printing system 1200 that includes sensors in an exemplary embodiment (a top view of printing system 1200 is shown in FIG. 13).

The pivoting of rollers 1212 and 1213 about axis 1220 is indicated in FIG. 12 by the vectors into and out of the page that are proximate to steering frame 1210. Steering frame 1210 is also able to pivot roller 1213 about axis 1222. The pivoting of roller 1213 is indicated in FIG. 12 by the vectors into and out of the page that are located proximate to roller 1213. Drive system 1214 operates to pivot rollers 1212 and 1213 as desired. Printing system 1200 also includes printer 1270 for marking onto web 120, as well as rollers 1230 for weaving web 120 towards printer 1270.

In this embodiment, printing system 1200 utilizes input from feed forward sensor 1240 as well as input from feedback sensor 1250 in order to determine how to adjust the orientation of its rollers. In this embodiment, each sensor indicates a positional offset of web 120, as well as an angular deviation of web 120. The angular deviation can be reported to controller 1260 as an angle, or may be reported as two positional offsets measured at different locations along the web. Given knowledge of the positional offset at each location, as well as the distance between the measurement locations for a sensor, controller 1260 can determine an offset angle of web 120 as it enters or leaves steering frame 1210.

Sensors 1240 and 1250 comprise any systems, components, or devices operable to detect shifts in web 120. For example, a sensor can comprise a laser, pneumatic, photoelectric, ultrasonic, infrared, optical, or any other suitable type of sensing device. In one embodiment, a sensor comprises a physical pressure sensor that can detect an amount of lateral force applied to it by web 120 during travel.

The feed forward information allows controller 1260 to predictively align steering frame 1210 in order to compensate for measured shifts in web orientation, and the feedback information allows controller 1260 to determine how well its predictive alignment processes are being performed. For example, feedback information can indicate whether an attempt to adjust an angle of web 120 is also causing a positional shift in web 120. Based on this feedback and/or feed forward information, controller 1260 can compensate for measured shifts in the position and/or angle of web 120 by directing the operations of drive system 1214. Controller 1260 may be implemented, for example, as custom circuitry, as a processor executing programmed instructions stored in an associated program memory, or some combination thereof.

Printing system 1200 also includes printer 1270 for marking onto web 120, as well as roller 1230 for weaving web 120 towards printer 1270.

Drive System Components

Now that several exemplary printing systems have been discussed in detail, exemplary components for drive systems capable of repositioning a roller will be discussed.

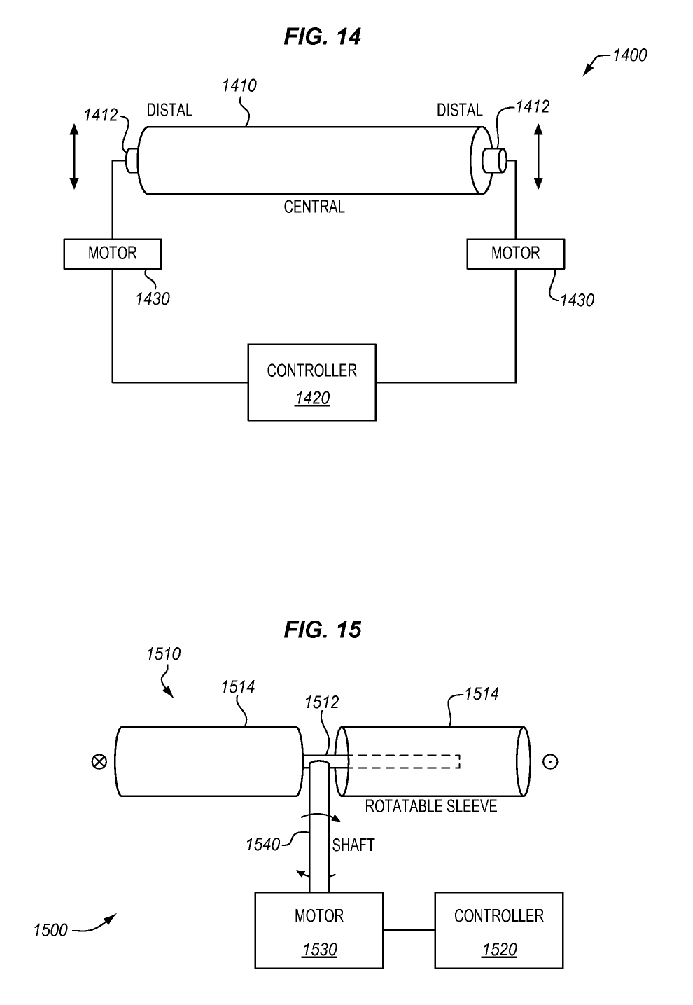

FIG. 14 is a diagram illustrating a drive system 1400 configured to adjust the position of a roller in an exemplary embodiment. Drive system 1400 includes controller 1420, which is capable of operating actuators 1430 (e.g., linear actuators) in order to adjust the positions of the ends of roller 1410, thereby pivoting roller 1410 about its center point and tilting its axis of rotation. Controller 1420 may be implemented for example as a hardware processor or circuit.

In one embodiment, the central portion of roller 1410 rolls independently while the mounts 1412 for roller 1410 remain fixed. Thus, roller 1410 can be pivoted about an axis and may still roll freely during printing.

FIG. 15 is a diagram illustrating an additional drive system 1500 configured to adjust the position of a roller in an exemplary embodiment. Drive system 1500 includes a actuator 1530, which is configured to pivot roller 1510 about its center by rotating shaft 1540. Controller 1520 directs the operations of actuator 1530, and controller 1520 may be implemented for example as a hardware processor or circuit.

In this embodiment, roller 1510 includes core 1512, which is pivoted, as indicated by the arrows, about shaft 1540. The pivoting of roller 1510 as shaft 1540 rotates is also indicated by the vectors into and out of the page for FIG. 15. Roller 1510 also includes one or more rotatable sleeves 1514, which roll about core 1512 when a web of print media travels over roller 1510. Thus, roller 1510 can be pivoted about an axis and may still roll freely during printing.

Computer Readable Media for Directing Steering Frame Operations

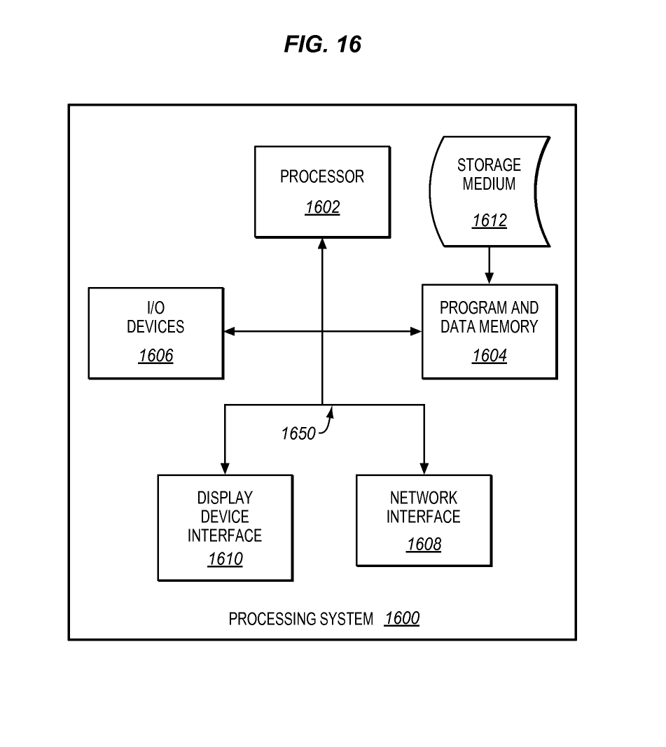

In one particular embodiment, software is used to direct a processing system of a controller of a steering frame to perform the various operations disclosed herein. FIG. 16 illustrates a processing system 1600 operable to execute a computer readable medium embodying programmed instructions to perform desired functions in an exemplary embodiment. Processing system 1600 is operable to perform the above operations by executing programmed instructions tangibly embodied on computer readable storage medium 1612. In this regard, embodiments of the invention can take the form of a computer program accessible via computer-readable medium 1612 providing program code for use by a computer or any other instruction execution system. For the purposes of this description, computer readable storage medium 1612 can be anything that can contain or store the program for use by the computer.

Computer readable storage medium 1612 can be an electronic, magnetic, optical, electromagnetic, infrared, or semiconductor device. Examples of computer readable storage medium 1612 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1600, being suitable for storing and/or executing the program code, includes at least one processor 1602 coupled to program and data memory 1604 through a system bus 1650. Program and data memory 1604 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1606 (including but not limited to keyboards, displays, pointing devices, etc.) can be coupled either directly or through intervening I/O controllers. Network adapter interfaces 1608 may also be integrated with the system to enable processing system 1600 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1610 may be integrated with the system to interface to one or more display devices, such as printing systems and screens for presentation of data generated by processor 1602.

Although specific embodiments were described herein, the scope of the invention is not limited to those specific embodiments. The scope of the invention is defined by the following claims and any equivalents thereof.

We claim:

1. An apparatus comprising:
a steering frame for a continuous-forms printing system, comprising:
a first roller oriented to tension a web of continuous-forms print media as the web proceeds through the steering frame;
a second roller oriented to tension the web as the web proceeds through the steering frame;
a first actuator configured to adjust a lateral position of the web by pivoting the first and second roller about a first axis; and
a second actuator configured to adjust a direction of the web in-plane with a surface of the web by pivoting the second roller about a second axis that is coplanar with the first axis.

2. The apparatus of claim 1, wherein:
the second roller turns about an axis of rotation as the web travels through the steering frame; and
the second axis is substantially perpendicular to the axis of rotation of the second roller.

3. The apparatus of claim 2, wherein:
the second actuator comprises an actuator configured to tilt the axis of rotation of the second roller.

4. The apparatus of claim 1, wherein:
the first axis does not intersect a component of the steering frame.

5. The apparatus of claim 1, wherein:
the first axis is located substantially within a plane defined by a surface of the web before the web enters the steering frame.

6. The apparatus of claim 1, further comprising:
a controller operable to reposition the web as the web travels through the steering frame by adjusting the first actuator and the second actuator to pivot the rollers about the axes.

7. The apparatus of claim 6, further comprising:
a feedback sensor operable to report a positional offset of the web after the web leaves the steering frame.

8. The apparatus of claim 7, wherein:
the controller is further operable to adjust the first actuator based on the positional offset.

9. The apparatus of claim 7, further comprising:
an additional feedback sensor operable to report an additional positional offset of the web after the web leaves the steering frame,
wherein the controller is further operable to determine a skew of the web based on the positional offset and the additional positional offset.

10. The apparatus of claim 9, wherein:
the controller is further operable to adjust the second actuator based on the skew.

11. The apparatus of claim 6, further comprising:
a feed forward sensor operable to report a positional offset of the web before the web enters the steering frame.

12. The apparatus of claim 11, wherein:
the controller is further operable to adjust the first actuator based on the positional offset.

13. The apparatus of claim 11, further comprising:
an additional feed forward sensor operable to report an additional positional offset of the web before the web enters the steering frame,
wherein the controller is further operable to determine a skew of the web based on the positional offset and the additional positional offset.

14. The apparatus of claim 13, wherein:
the controller is further operable to adjust the second actuator based on skew.

15. A method for operating a steering frame comprising multiple rollers in order to adjust a web of print media, the method comprising:
identifying a positional offset of a web of print media proceeding through a steering frame of a printing system;
identifying a skew of the web in-plane with a surface of the web;
pivoting multiple rollers of the steering frame about a first axis based on the positional offset; and
pivoting one of the multiple rollers about a second axis that is coplanar with the first axis based on the skew.

16. The method of claim 15, wherein:
the step of pivoting the multiple rollers is performed while the printing system is printing; and
the step of pivoting one of the multiple rollers is performed while the printing system is printing.

17. The method of claim 16, further comprising:
identifying the positional offset based on sensor input describing a position of an edge of the web as it travels through the printing system.

18. The method of claim 16, further comprising:
identifying the skew based on multiple sensor inputs that each describe a position of an edge of the web as it travels through the printing system.

19. An apparatus comprising:
a frame;
a first roller that is rotatably attached to the frame and oriented to support a web of continuous-forms print media that travels through the apparatus;
a second roller that is rotatably attached to the frame and oriented to support the web;
a first actuator configured to pivot the frame about a first axis; and
a second actuator configured to pivot the second roller about a second axis that is coplanar with the first axis.

20. The apparatus of claim 19, wherein:
the second roller turns about an axis of rotation as the web travels through the apparatus; and
the second axis is substantially perpendicular to the axis of rotation of the second roller.
